(19) United States
(12) Patent Application Publication
(10) Pub. No.: US 2026/0281497 A1
(43) Pub. Date: Sep. 17, 2026

(54) Client-Side Targeted Content Substitution for In-Home Streaming Device

(71) Applicant: Synamedia Limited, Maidenhead (GB)

(72) Inventor: James Leigh Cunningham, Hampshire (GB)

(21) Appl. No.: 19/082,163

(22) Filed: Mar. 17, 2025

(51) Int. Cl. H04N 21/44; H04N 21/436; H04N 21/442; H04N 21/472

(52) U.S. Cl. CPC H04N 21/44016; H04N 21/43615; H04N 21/44204; H04N 21/47217

(57) ABSTRACT

Techniques for client-side targeted content substitution are described herein. In various embodiments, a client device (e.g., a gateway device) including network interfaces, one or more processors and non-transitory memory is connectable to one or more multi-room devices. The client device receives broadcast signals carrying a splice message and obtains viewing reports from the one or more multi-room devices. The client device also maintains a substitution playlist based at least in part on the splice message derived from the broadcast signals and the viewing reports, where the substitution playlist indicates transitions among a media stream and one or more targeted content items. Further, the client device signals the transitions to the one or more multi-room devices. Additionally, the client device causes the one or more multi-room devices to splice the media stream using the one or more targeted content items according to the transitions.

### TECHNICAL FIELD

The present disclosure relates generally to media content delivery and, more specifically, to client-side targeted content substitution for in-home streaming device.

### BACKGROUND

In an in-home streaming network, streaming services are provided through the provision of a gateway (GW) device and one or more multi-room (MR) devices. Streaming services (e.g., broadcast services) typically are received by the GW, where streaming content is conditional access (CA) terminated and digital rights management (DRM) protected before being stored on local storage or streamed to the MR using a secure streaming protocol. Among the content being streamed, targeted content refers to media content items specifically created and distributed to a particular audience segment based on their demographics, interests, and behaviors, ensuring the items are highly relevant to each individual viewer. Unlike traditional TV advertisements with fixed schedules, streaming enables flexible substitution of targeted content, allowing for personalized message delivery that resonates with viewers.

Targeted content substitution often relies on local storage to store the targeted content used during substitution and on the acquisition of broadcast signals to identify substitution spots. Additionally, GW devices typically have the capability to acquire the broadcast signals, identify substitution spots, manage campaigns, and make targeted content substitution decisions based on various business rules. Currently, none of these services are available on the MR device(s). As such, extending the targeted content substitution capability from the GW to the MR device(s) is a non-trivial addition.

### BRIEF DESCRIPTION OF THE DRAWINGS

So that the present disclosure can be understood by those of ordinary skill in the art, a more detailed description may be had by reference to aspects of some illustrative embodiments, some of which are shown in the accompanying drawings.

FIG. 1 is a block diagram illustrating an exemplary in-home streaming system with client-side targeted content substitution, in accordance with some embodiments;

FIG. 2 is a block diagram illustrating a splicing model for live content substitution, in accordance with some embodiments;

FIG. 3 is a diagram illustrating an exemplary timeline for targeted content substitution, in accordance with some embodiments;

FIG. 4 is a sequence diagram illustrating live content substitution, in accordance with some embodiments;

FIG. 5 is a block diagram illustrating a splicing model for playback substitution, in accordance with some embodiments;

FIG. 6 is a diagram illustrating an exemplary timeline for playback substitution, in accordance with some embodiments;

FIG. 7 is a flowchart a method for client-side targeted content substitution for in-home streaming device, in accordance with some embodiments; and

FIG. 8 is a block diagram of an in-home streaming device for client-side targeted content substitution, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DESCRIPTION OF EXAMPLE EMBODIMENTS

Numerous details are described in order to provide a thorough understanding of the example embodiments shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example embodiments described herein.

### Overview

Methods, devices, and systems described herein perform client-side targeted content substitution in an in-home streaming network that includes a gateway device and multi-room (MR) device(s). Client-side targeted content substitution requires the client device to detect the out-points and in-points for each media stream, splicing to the targeted content streams during substitution and splicing back to the media streams at the end of substitution, including support for back-to-back targeted content substitutions. In various embodiments, for live content substitution, the multi-room device manages these transitions and performs the splicing using the splice definitions provided by the gateway device whilst maintaining streaming with the gateway device. For playbacks, the streaming solution described herein between the gateway and MR device(s) supports server-side trick modes, with the gateway responsible for monitoring playback position (including end of media) and controlling trick-play, e.g., fast forward, rewind, seek, etc. In some embodiments, the gateway hands over trick-play control to the multi-room device(s) during the targeted content substitution and regains control when transitioning back to the media stream viewing.

In accordance with various embodiments, a client device (e.g., a gateway device) including network interfaces, one or more processors, and non-transitory memory is connectable to one or more multi-room devices. The client device receives broadcast signals carrying a splice message and obtains viewing reports from the one or more multi-room devices. The client device also maintains a substitution playlist based at least in part on the splice message derived from the broadcast signals and the viewing reports, where the substitution playlist indicates transitions among a media stream and one or more targeted content items. Further, the client device signals the transitions to the one or more multi-room devices. Additionally, the client device causes the one or more multi-room devices to splice the media stream using the one or more targeted content items according to the transitions.

### Example Embodiments

Methods, devices, and systems described herein extend seamless targeted content substitution to multi-room (MR) device(s). In various embodiments, targeted media content (also referred to hereinafter as targeted content, substitution content, substitution asset, or substitution) is stored on a gateway device (GW) in a household or on a content delivery network (CDN) and streamed to the MR devices for splicing of live content or playback content (also referred to hereinafter as the main content or main media content). Depending on whether the main content is live content or playback content, various connection(s) between interfaces (also referred to hereinafter as the interface connection(s)) are established for signaling and sending audio and video (AV) data to the MR device(s), and pipeline(s) are configured on the MR device(s) to demultiplex and decode the audio and video data. The MR device(s) perform the splicing and report back the transition states to the GW device so that the targeted content can be managed at the household level.

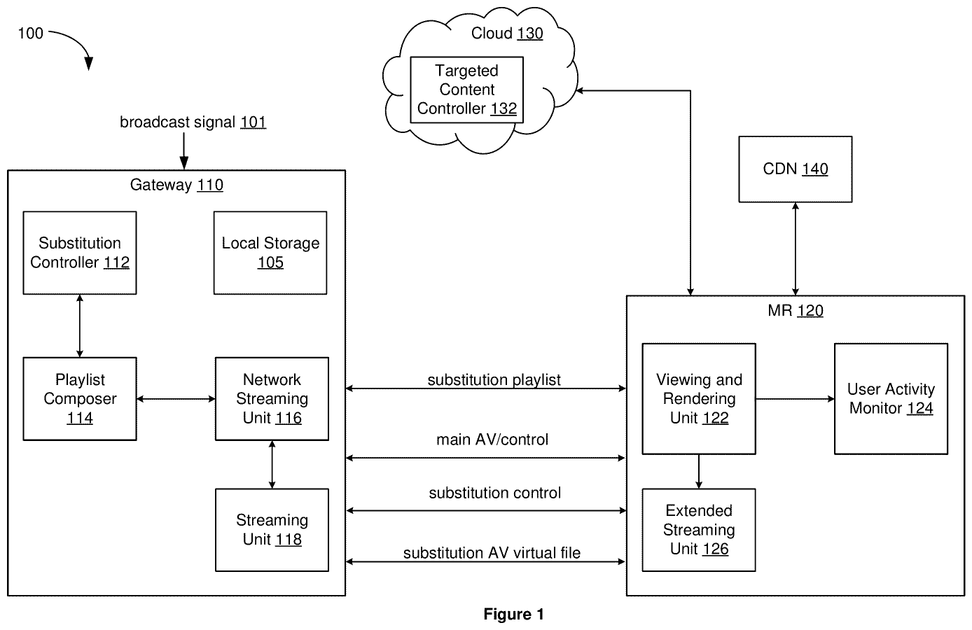

Reference is now made to FIG. 1, which is a block diagram of an exemplary in-home streaming system 100 in accordance with some embodiments. In some embodiments, the exemplary in-home streaming system 100 includes a GW device 110 and an MR device 120. In some embodiments, the GW device 110 includes tuner(s) and/or demodulator(s) for receiving broadcast services and extracting streaming data in broadcast signals for a house, e.g., connecting to a satellite dish. In comparison, in some embodiments, a respective MR device 120 communicatively coupled with the GW device 110, e.g., through wired or wireless connections, and paired with a TV, e.g., plugged into a TV High-Definition Multimedia Interface (HDMI) port. Using multiple MR devices 120 in a house and each paired with a respective TV and connectable to the GW device 110, multiple TVs in the house can simultaneously display various programs the household is subscribed to. As will be described in further details, in some embodiments, the MR device 120 receives chunk inputs from the GW device 110 and configures one or more pipelines for content viewing, and each MR device 120 in a household is connected to a remote control for receiving user inputs in accordance with various embodiments.

In some embodiments, the GW device 110 includes a substitution controller 112 to manage targeted content and campaigns at the household level. In some embodiments, the broadcast signal 101 received by the GW device 110 includes live and/or recording content as well as signalization for targeted media content, e.g., the splice information. In some embodiments, during recording of broadcast content, the GW device 110 captures and indexes rules and splice information messages (also referred to hereinafter as the splice messages), e.g., based on section filtering of the stream, and saves them with the recorded stream.

In some embodiments, the targeted content and the campaigns are downloaded by the GW device 110 (e.g., using broadcast medium to download the targeted media content) and stored in a local storage 105. Based on the broadcast signal 101, the substitution controller 112 along with other components on the GW device 110 performs rule evaluation to decide whether to substitute content and choose which asset stored in the local storage 105 would be used for substitution, and allows assets to be deleted from the local storage 105 when no longer in use. It should be noted that one or more functions performed by the substitution controller 112 can be performed by one or more units shown in FIG. 1 or not illustrated in FIG. 1. For example, the lifetime of the targeted media content is related to the set of targeted campaigns, e.g., a set of advertising activities designed to deliver specific advertisements to a target audience within a streaming video. In some embodiments, the set of targeted campaigns is governed by a campaign manager (not shown), separate and distinct from the substitution controller 112 performing the targeted content decisioning.

In some embodiments, the GW device 110 also includes a playlist composer 114 coupled with the substitution controller 112 for building and managing the substitution playlist and maintaining playlist updates using the information provided by the substitution controller 112. As such, the substitution playlist and/or the playlist updates are the evaluation results of rules, splice information, and/or reports from the MR device 110. In some embodiments, the playlist composer 114 captures the rules and splice messages from the broadcast signal 101. In some embodiments, the rules define the set of campaigns for substitution in a spot, e.g., a designated period or time slot within a video stream where advertisements are typically shown. In some embodiments, the splice messages define the position and duration of a spot.

In some embodiments, the playlist composer 114 sends the rules to the substitution controller 112, so that the substitution controller 112 decides which campaign would be used for substitution according to the rules and returns the targeted content selections to the playlist composer 114. In other words, the rules message carried by the broadcast signal 101 is acquired by the playlist composer 114 and evaluated by the substitution controller 112 for targeted content selection. The information provided by the substitution controller 112 to the playlist composer 114 is the result of the evaluation, e.g., whether a substitution is to be made and if so, what asset to use for substitution, etc. Further, in some embodiments, the playlist composer 114 maintains a playlist, which is a list of media content items streamed one after the other. The media content items in the list include main items, which refer to main assets (denoted as M), and substitution items (denoted as S), which refer to targeted content.

In some embodiments, the GW device 110 includes a network streaming unit 116 for sending updates of playlist entries to the MR device 120 via a substitution playlist connection, obtaining viewing reports from the MR device 120 about substitutions, transitions, and viewing activities, and reporting such information to the playlist composer 114 for playlist updates. In some embodiments, the GW device 110 additionally includes a streaming unit 118 for extending content and control signals to the MR device 120. In some embodiments, the streaming unit 118 provisions (e.g., opens and closes) interface connection(s) with the MR device 120 according to the signaling from the network streaming unit 116, e.g., when there is playlist updates indicating substitutions.

On the MR device 120, a user activity monitor 124 monitors viewing activities and coordinates with a viewing and rendering unit 122 to report the viewing activities at the MR device 120, e.g., substitutions and transitions. In some embodiments, the viewing and rendering unit 122 produces frame accurate detection of when the first frame has been viewed for campaign capping (e.g., a limit on the number of times a targeted content item is shown to a user) and spacing (e.g., the time between showing two consecutive targeted content items), etc. Upon receiving reports from the viewing and rendering unit 122, the network streaming unit 116 on the GW device 110 coordinates with the playlist composer 114 to update the substitution playlist based on the reports. In some embodiments, the viewing and rendering unit 122 sends events to the user activity monitor 124. The user activity monitor 124 then uses the viewing activities to fulfil reporting and/or billing purposes.

Also on the MR device 120, an extended streaming unit 126 uses interface(s) for obtaining the targeted content for substitution as well the signaling from the GW device 110 and performs substitutions (e.g., substitution stitching or splicing) according to the signaling. For example, main audio/video (AV) and control interfaces are used to create connections between the GW device 110 and the MR device 120 for exchanging the main live and/or playback content. In another example, the GW device 110 and the MR device 120 establish a substitution control interface connection to allow the MR device 120 to send commands to the GW device 110 during substitution. In still another example, the GW device 110 exposes an interface (e.g., a substitution audio/video (AV) interface) to the MR device 120 and the MR device 120 connects to this interface for exchanging targeted content during substitution. As such, the substitution AV interface is available to the MR device 120 following discovery of the GW device 110. In some embodiments, the GW device 110 provides a substitution playlist interface automatically as part of establishing the connection for live or playback content and makes the substitution playlist available to the MR device 120. When a new playlist entry is available, through the substitution playlist interface, the GW device 110 sends a message to the MR device 120 indicating playlist updates.

It should be noted that some of the interfaces shown in FIG. 1 are not used at all times. For example, during a playback steady state phase, the GW device 110 sends substitution playlist updates to the MR device 120 via the substitution playlist interface. The MR device 120 uses this interface to maintain a playback substitution window (also referred to hereinafter as the playback window, the substitution window, or the substitution lookahead window) and fetch splice information from the GW device 110, so it knows when to start substitution and which substitution asset to use, etc. Similarly, the MR device 120 sends viewing reports to the GW device 110 via the substitution playlist interface to help manage the playlist in the steady state phase and feed capping and spacing rules evaluation, etc.

In some embodiments, the substitution playlist interface is not used by the MR device 120 for reporting time critical messages when the substitution decisioning is not performed on the GW device 110. In such embodiments, rules and splice information derived from broadcast signals 101 are sent by the GW device 110 to the MR device 120 via the substitution playlist interface, with the MR device 120 managing the playlist locally. In such embodiments, the MR device 120 detects whether a substitution is happening or not, while the GW device 110 does not necessarily know which opportunities result in a decision to substitute. It is also possible that spots may be skipped in case the MR device 120 has a problem getting ready for the substitution. Regardless of where the playlist is managed and where substitution decisioning is performed, when it comes to splicing, the MR device is the source of truth. As such, the substitution control interface (separate and distinct from the substitution playlist interface) is used for sending time critical messages from the MR device 120 to the GW device 110, where the time critical messages are synchronized with the splicing operations performed on the MR device 110 in accordance with some embodiments. The control messages sent via the substitution control interface modify the GW device 110 streaming activities for main content and allow for substitution spots to be missed or fulfilled in real-time. Because live viewing does not require the real time control of the GW device 110 streaming, the substitution control interface is not used or necessary for live viewing in accordance with some embodiments.

As will be described in further detail below, there are two substitution cases. One is isolated substitution, where the viewing and rendering unit 122 prepares to access targeted content before a single substitution starts and then stops when the single substitution completes. The other case involves multiple back-to-back substitutions. In back-to-back substitutions, while a substitution asset N (denoted as S(N)) is playing, the viewing and rendering unit 122 receives splicing information for an incoming substitution asset N+1 (denoted as S(N+1)). In response, the viewing and rendering unit 122 prepares to access substitution asset N+1, so that as soon as the out point of the substitution asset N is reached, the extended streaming unit 126 autonomously starts playing the substitution asset N+1 and notifies the viewing and rendering unit 122 that the substitution asset N has completed.

Using the exemplary in-home streaming system 100, the GW device 110 continues to capture the broadcast signal 101, e.g., based on section filtering of the stream, and derives the splice information for extending substitution to the MR device 120. The splicing or substitution stitching is performed on the MR device 120. However, campaign and targeted content substitution decisions are made at the household level and continue to the take place on the GW device 110 in accordance with some embodiments.

For example, the substitution controller 112 can use the reports from the MR device 120 to evaluate against rules and choose which asset in the local storage 105 would be used for substitution. Moreover, through the interface connections, managing the playlist is proxied by the GW device 110 to the MR device 120 for improved efficiency. The GW device 110 builds and manages the substitution playlist. During playback, the GW device 110 uses read ahead to obtain rules and splice information up front efficiently for fast trick modes support on the MR device 120. Further, the GW device 110 and the MR device 120 coordinate to manage a playback window to minimize hard real-time dependencies. For seamless splicing, the MR device 120 detects and reports when the first frame has been viewed and reports for frame accurate campaign capping and spacing, while the GW device 120 uses the reported information to update the campaign catalog in accordance with various embodiments.

It should be noted that although a single MR device 120 is illustrated in FIG. 1, the system 100 may include one or more MR devices 120, e.g., multiple smart TVs or set-top-boxes connecting to the same gateway 110 in a house. For the sake of simplicity, the subject matter is described herein for the most part with reference to a single MR device 120. Further, one or more components and/or functions of the components illustrated in FIG. 1 may be distributed and/or re-arranged. For example, one or more components of the GW device 110 can be distributed and/or re-arranged to a cloud 130.

In some embodiments, the targeted content substitution decisions are made on the GW device 110, where the targeted content is downloaded to the GW device 110 ahead of time and stored in the local storage 105. In some other embodiments, the cloud 130 includes a targeted content controller 132 for making substitution decisions, e.g., performing the functions of one or more of substitution controller 112, the playlist composer 114, the network streaming unit 116, and the streaming unit 118 in the cloud 130. In such embodiments, the cloud 130 directs the MR device 120 to download the targeted content from a CDN 140 for substitution on the MR device 120. Also in such embodiments, the functions of one or more substitution controller 112, the playlist composer 114, and the network streaming 116 can be re-arranged and/or distributed between the targeted content controller 132 and the MR device 120. For example, when the targeted content controller 132 makes the targeted content decision in the cloud 130, the playlist composer 114 can be moved to the MR device 120, and the role of the network streaming unit 116 can be reduced to providing the rules and splice information from the broadcast and/or recorded stream to the MR device 120.

As such, the cloud 130, the GW device 110, and the MR device 120 in the content delivery system 100 can include more, less, and/or different elements than shown in FIG. 1. Each of the component in the content delivery system 100 can include appropriate hardware, software, and/or firmware to perform the operations attributed to the element herein. Operation(s) attributed to an element in the content delivery system 100 herein should not be considered binding and in some embodiments, other element(s) in the exemplary system 100 may additionally or alternatively perform such operation(s).

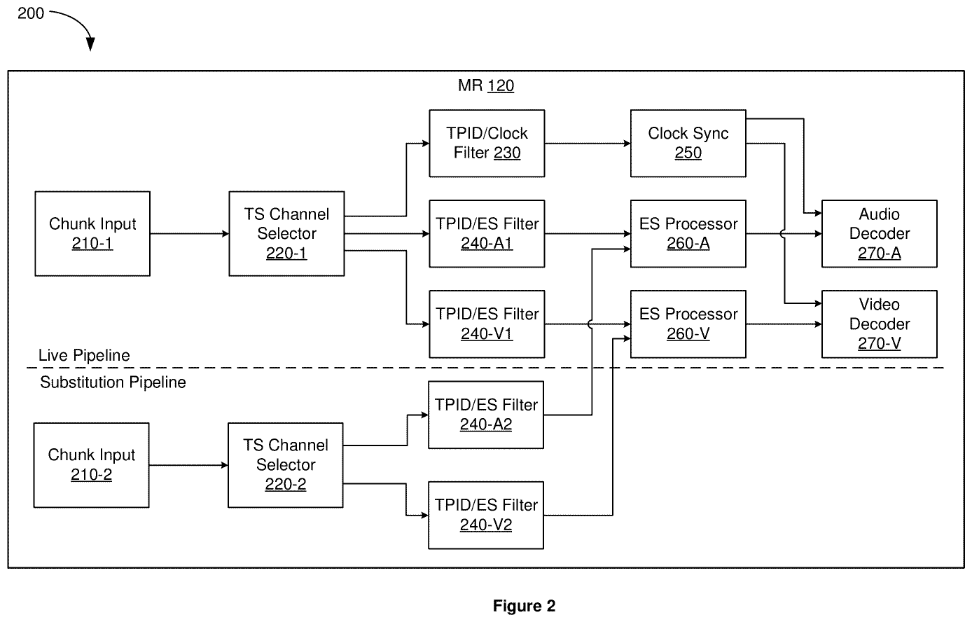

FIG. 2 is a diagram 200 illustrating a splicing model for live content substitution on the MR device 120 in accordance with some embodiments. As used herein, live content substitution (or live substitution) refers to substituting live streaming main content with targeted content. In some embodiments, two pipelines are configured on the MR device 120, namely a live streaming pipeline (also referred to as the live pipeline) for processing live content and a substitution pipeline for processing targeted media content. In some embodiments, the MR device 120 is communicatively connectable to the GW device 110 (FIG. 1) and includes one or more processors, non-transitory memory for storing buffered content, metadata, programs, etc., and communication interfaces for directly or indirectly connecting to the GW device 110 (FIG. 1), the cloud 130 (FIG. 1), the CDN 140 (FIG. 1), and/or a display device, such as a TV. For instance, the GW device 110 (FIG. 1) can not only provide the streaming content, but also act as a WiFi booster to provide internet connections for the MR device 120. Through such internet connections, the MR device 120 can obtain targeted content from the cloud 130 (FIG. 1) and/or the CDN 140 (FIG. 1) without connecting directly to a satellite dish. In such configurations, the MR device 120 does not have a tuner or demodulator for processing broadcast signals and does not make targeted content selections in accordance with some embodiments, thus reducing the cost of the MR device 120 and retaining the targeted content delivery at the household level by the GW device 110 (FIG. 1).

In some embodiments, the MR device 120 receives the main content (e.g., live content) from the GW device 110 (FIG. 1) and feeds chunk input 10-1 to a first transport stream (TS) channel selector 220-1. In some embodiments, the MR device 120 receives the targeted content from the GW device 110 (FIG. 1) and/or the CDN 140 (FIG. 1) and feeds chunk input 210-2 to a second TS channel selector 220-2. The chunk input 210 can be units from Moving Picture Experts Group (MPEG) transport streams or elements of compressed video and audio streams following other streaming protocols. Though FIG. 2 illustrates feeding the chunk inputs 210 (e.g., the chunk input 210-1 and the chunk input 210-2) and using the TS channel selectors 220 (e.g., the first TS channel selector 220-1 and the second TS channel selector 220-2) for demultiplexing, when demultiplexed elementary streams are available, elements of the compressed video and audio streams can be fed directly to elementary stream processors 260-A and 260-V.

For the live pipeline, in some embodiments, the MR device 120 includes the TS channel selector 220-1 for obtaining stream data corresponding to the channel for live streaming content. The stream data derived by the TS channel selector 220-1 are then provided to a transport packet identifier (TPID) filter 230 for deriving clock reference and to TPID elementary stream (ES) filters 240-A1 and 240-V1 for obtaining audio and video transport packets (TPs) in the live stream based on packet identifiers (PIDs). A clock synchronization unit 250 coupled with the clock filter 230 is configured to synchronize the clock on the MR device 120 with the time of the live stream derived by the clock filter. The clock synchronization unit 250 is further coupled with an audio decoder 270-A and a video decoder 270-V, so that the presentation timeline on the MR device 120 remains synchronized with the live stream. The synchronization ensures seamless splice, e.g., transitions between the targeted content viewing back and the live stream viewing are frame accurate.

For the substitution pipeline, in some embodiments, the MR device 120 includes the TS channel selector 220-2 for obtaining stream data corresponding to the channel for targeted media content. The stream data derived by the TS channel selector 220-2 are then provided to TPID elementary stream (ES) filters 240-A2 and 240-V2 for obtaining audio and video transport packets (TPs) in the substitution playback based on packet identifiers (PIDs). As shown in FIG. 2, the audio data from the ES filter 240-A1 in the live viewing pipeline and from the ES filter 240-A2 in the substitution pipeline are sent to a single rate buffer and audio decoder 270-A via an ES processor 260-A. Likewise, the video data from the ES filter 240-V1 in the live viewing pipeline and from the ES filter 240-V2 in the substitution pipeline are sent to a single rate buffer and video decoder 270-V using an ES processor 260-V. As such, the ES processors 260 (e.g., the ES processor 260-A for audio and the ES processor 260-V for video) are shared by the live pipeline and the substitution pipeline. So are the audio decoder 270-A and the video decoder 270-V.

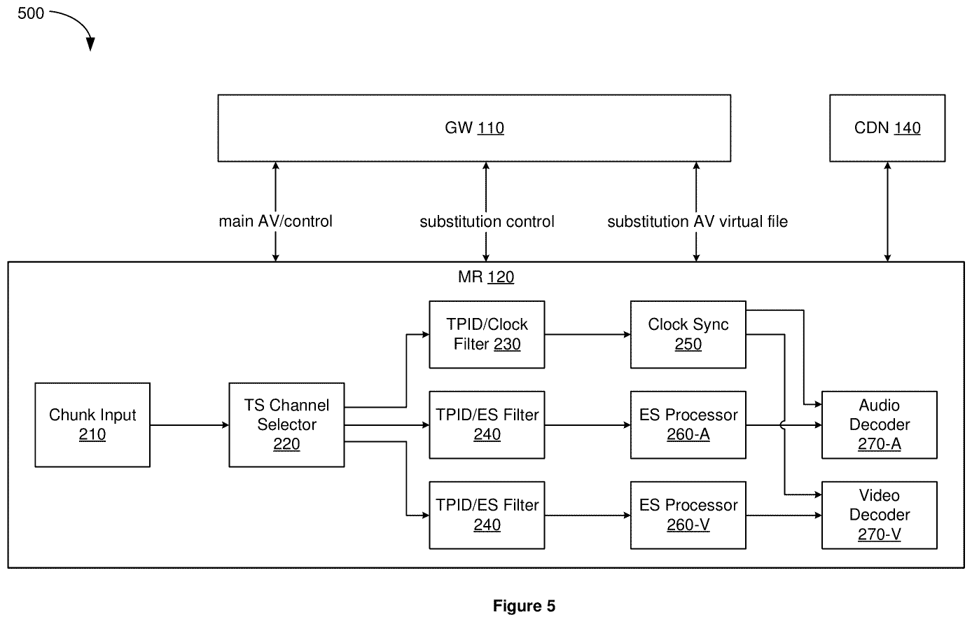

In some embodiments, to configure the additional pipeline for the substitution, the live pipeline is modified to include the additional and separate feed from the substitution pipeline to the ES processors 260 in the device chain. The dual demultiplexing model is different from a single pipeline model for playback substitution. As will be shown and described in further detail below with reference to FIG. 5, for playback substitution, while targeted content substitution is taking place, data from the main content file are not required. Consequently, playback substitution requires only one playback instance at any given point, and the single pipe model for playback substitution involves one instance of demultiplexing, i.e., one rate buffer per ES and one decoder per ES, all of which are shared for main content file playback and for substituted playback.

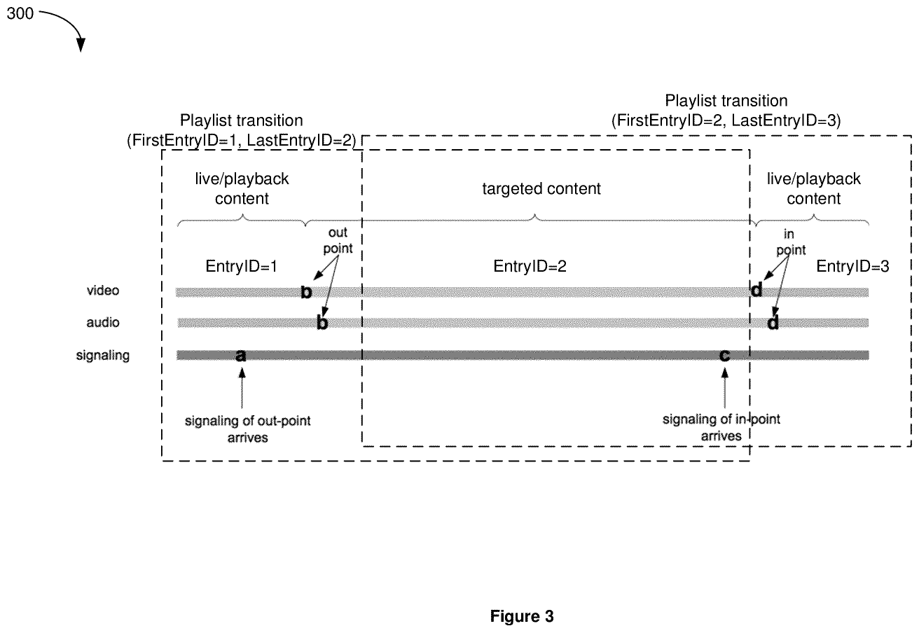

FIG. 3 is a diagram illustrating an exemplary timeline 300 for targeted content substitution in accordance with some embodiments. The exemplary timeline 300 illustrates while a user is viewing live or playback content with a corresponding entry identifier (ID) value of 1, at time (a), the GW device 110 (e.g., the playlist composer 114, FIG. 1) receives signaling on a private PID within the tuned service (e.g., the broadcast signal received via a tuner of the GW device 110 for a selected channel) indicating an optional substitution at out-points (b). Due to the nature of broadcasting, video and audio packets arrive at different time. Consequently, in some embodiments, the splice messages indicate one out-point for video and another out-point for audio. Subsequently, the GW device 110 (FIG. 1) signals to the MR device 120 (FIGS. 1 and 2) about a substitution playlist update to indicate the optional substitution at the out-point (b), e.g., via the substitution playlist interface connection as described with reference to FIG. 1. In some embodiments, the signaling to the MR device 120 (FIGS. 1 and 2) includes the presentation timestamps (PTS) of (b) and the duration of the substitution.

For substitution, e.g., to substitute a portion of the main content with the targeted content having a corresponding entry ID value of 2, the time offsets of (b) within the playback is known. In other words, the GW device 110 (FIG. 1) has the playback positions at which points (b) occur in the recorded multiplexed stream. When the video and/or audio for the main content at points (b) arrive at the MR device 120 (FIGS. 1 and 2), the playing of live or playback content is terminated and playback of the targeted content with entry ID value of 2 begins. Towards the end of the targeted content, the playlist composer 114 (FIG. 1) receives the broadcast signaling indicating the arriving of the in-points at time (c). The MR device 120 (FIGS. 1 and 2) is then notified of the PTS of the in-points (d) in the live broadcast via the substitution playlist update, e.g., via the substitution playlist interface connection. For playback of the substitution, the time offset of the in-points (d) within the playback is also known. The MR device 120 (FIGS. 1 and 2) rejoins the live or playback of the main content broadcast with a corresponding entry ID value of 3 in time to decode and render at in-points (d).

FIG. 3 also shows exemplary sliding playback windows, as indicated by the rectangles with dashed borderlines. In some embodiments, the GW device 110 (FIG. 1) signals the playlist entries within the current playback window. As described above with reference to FIG. 1, the network streaming unit 116 signals the MR device 120 (FIGS. 1 and 2) playlist updates via the substitution playlist interface. For example, when the user is viewing the main content with the entry ID value of 1, the current playback window includes the main content and the targeted content with the entry ID value of 2, e.g., (FirstEntryID=1, LastEntryID=2). In another example, when the user is viewing the targeted content with the entry ID value of 2, the current playback window includes the targeted content and the main content that would be rejoined with the entry ID value of 3, e.g., (FirstEntryID=2, LastEntryID=3).

The example shown in FIG. 3 illustrates a single targeted content substitution. As will be described in further detail below, when the main content is playback content (e.g., recorded content), in response to the playlist updates sent to the MR device 120 (FIGS. 1 and 2), in addition to get next transition, actions taken by the MR device 120 (FIGS. 1 and 2) include get previous transition, start to look ahead, or stop looking ahead, etc. to facilitate the transition. Including transitions in both directions in playback windows allows the MR device 120 (FIGS. 1 and 2) and/or the GW device 110 (FIG. 1) to be aware of transitions ahead of time to cater for trick play in both the forward and reverse directions.

Though not shown in FIG. 3, in some embodiments, the MR device 120 (FIGS. 1 and 2) generates viewing reports and sends the viewing reports to the GW device 110 (FIG. 1). In some embodiments, the viewing reports indicate the entry ID, the event type (e.g., stop, start, etc.), and other report information. For example, when transitioning from the live/playback content with the event ID value 1 into the targeted content with the event ID value of 2, the MR device 120 reports (EntryID=1, stop, reportInfo) to indicate exiting the display of the live/playback content and reports (EntryID=2, start, reportInfo) to indicate entering the display of the targeted content. In another example, when transitioning from the targeted content with the event ID value of 2 into the live/playback content with the event ID value 3, the MR device 120 reports (EntryID=2, stop, reportInfo) to indicate exiting the display of the targeted content and reports (EntryID=3, start, reportInfo) to indicate entering the display of the live/playback content. In some embodiments, the viewing reports are used by the substitution controller 112 to decide campaign selections, such as campaign capping and spacing.

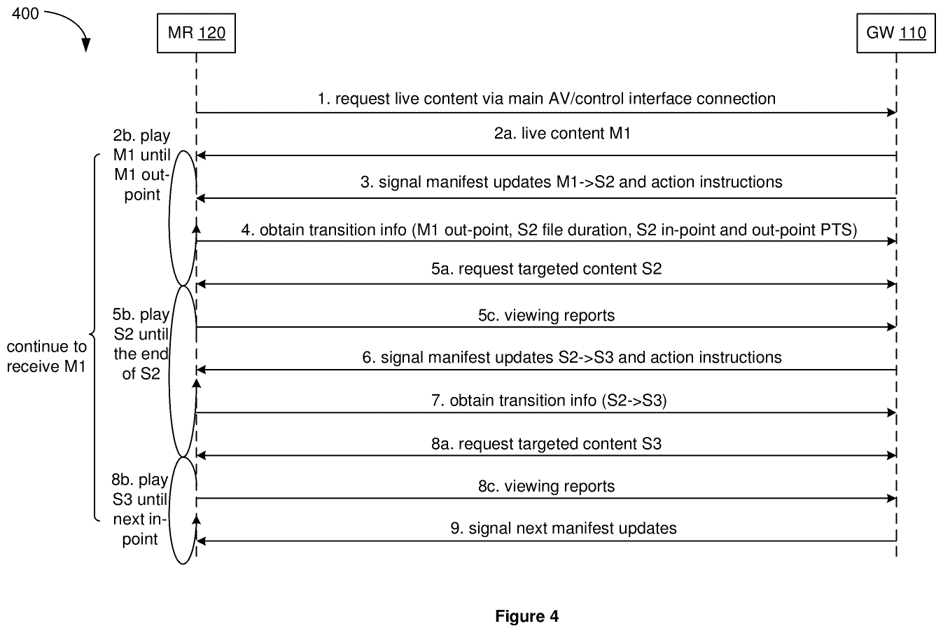

FIG. 4 is a sequence diagram 400 illustrating live content substitution using multiple back-to-back targeted content items in accordance with some embodiments. The exemplary sequence of live content substitution includes transitioning from main content (denoted as M1) to a first targeted content item (denoted as S2) and then to a second targeted content item (denoted as S3) and so on. In step 1, the MR device 120 requests live content (e.g., with an entry ID of M1) via the main AV and control interfaces, for which an interface connection is established for all live and playback requests. In step 2a, upon establishing connections via the main AV and control interfaces, the GW device 110 streams live content to the MR device 120, which in turn plays live content M1 in step 2b. The MR device 120 continues to stream live content M1 from the GW device 110 for live viewing, e.g., through the live pipeline as shown in FIG. 2, until transitioning to targeted content S2.

In step 3, the GW device 110 notifies the MR device 120 whenever a new playlist entry is available for S2, e.g., sending a message from the GW device 110 to the MR device 120 over the connection to the substitution playlist interface established in step 1 indicating playlist updates of (FirstEntryID=M1, LastEntryID=S2). The request in step 4 allows the MR device 120 to request the transition information between the current playlist entry (e.g., M1) and the next playlist entry (e.g., S2). In some embodiments, each play transition is comprised of two entry IDs, i.e., the entry ID before and after the transition, and the transition information (i.e., the splice definition) covering the transition between the current entry (e.g., M1) and the next entry (e.g., S2). In some embodiments, the transition information signaling from GW device 110 indicates out-point in live stream M1, duration of the substitution file for S2, and the in-point and out-point PTS of the substitution S2. According to the transition information signaling, the play of live content M1 continues until the out-point PTS in live content M1 is detected in accordance with some embodiments.

In step 5a, the MR device 120 opens an interface connection to request the targeted content (e.g., S2) from the GW device 110 during targeted content substitution and play in step 5a. In some embodiments, the GW device 110 accepts the request for content on-demand via the substitution AV interface to support serving targeted content S2 using various virtual file streaming formats. In step 5b, the MR device 120 continues to play targeted content S2 until transitioning to targeted content S3. In step 5c, the MR device 120 generates and sends viewing reports to the GW device 110. In some embodiments, the viewing reports indicate the entry ID, the event type, and other report information. For example, the MR device 120 reports (EntryID=M1, stop, reportInfo) prior to exiting M1 to indicate ending the display of the last frame of M1 and reports (EntryID=S2, start, reportInfo) after exiting M1 but before entering S2 to indicate entering the display of the first frame of targeted content S2.

In step 6, through the substitution playlist interface, the GW device 110 notifies the MR device 120 when a new playlist entry for S3 is available, e.g., sending a message from the GW device 110 to the MR device 120 over the substitution playlist interface indicating playlist updates of (FirstEntryID=S2, LastEntryID=S3). The request in step 7 allows the MR device 120 to request the transition information between the current playlist entry (e.g., S2) and the next playlist entry (e.g., S3), e.g., obtaining the transition information signaling from GW device 110 indicates out-point in the substitution content S2, duration of substitution file S3, and the in-point and out-point PTS of the substitution S3.

In step 8a, the MR device 120 closes the interface connection for S2, e.g., terminating the request for targeted content S2, and opens a new interface connection to request targeted content S3 from the GW device 110 during targeted content substitution and play in step 8b, e.g., using the substitution AV interface. In step 9c, the MR device 120 generates and sends viewing reports to the GW device 110, e.g., sending the viewing reports indicating (EntryID=S2, stop, reportInfo) prior to exiting S2 to indicate ending the display of the last frame of S2. Also in step 8c, the MR device 120 reports (EntryID=S3, start, reportInfo) after exiting S2 but before entering S3 to indicate entering the display of the first frame of targeted content S3.

The process continues and the substitution asset S3 continues to play until next playlist updates are signaled in step 9 and the MR device 120 starts to process next point from the in-point PTS signaled by the GW device 110. As such, based on the transition information signaling, the MR device 120 knows when it has delivered the last chunk of a substitution asset and when to start the next substitution, prepares to transition, and reports to the GW device 110 when it has completed a transition.

As shown in FIG. 4, at any one time, the MR device 120 has two separate interface connections open for streaming content, one for the live content and the other one for the substitution asset. When having back-to-back substitutions, e.g., from S2 to S3, the MR device 120 terminates the request for targeted content S2 before requesting to pull targeted content S3 from the GW device 110. In some embodiments, each substitution asset is stored and served in the clear, e.g., stored in the local storage 105 (FIG. 1) in clear and transmitted using the virtual file streaming format unencrypted. The GW device 110 thus accepts requests on-demand to support serving the substitution assets to the MR device 120.

Also shown in FIG. 4, an entry in the playlist can be for either main content or substitution content. The MR device 120 uses the substitution pipeline to receive the targeted content for substitution. The GW device 110 continues to stream the live content to the MR device 120 using via the main AV interface, which is separate and distinct from the substitution AV interface for the targeted content. Further, for live content substitution, the MR device 120 continues to receive the live content from the GW device 110 using the live pipeline while buffering the substitution content and priming the system time clock prior to start decoding to ensure the program clock reference (PCR) remains locked. It is essential that the PCR is locked to the live stream at the point that content from the substitution asset starts to be consumed to ensure seamless splice.

FIG. 5 is a diagram 500 illustrating a single demultiplexing pipeline splicing model for playback substitution in accordance with various embodiments. Similar to live substitution, the substitution asset is streamed out-of-band of the existing streaming interface to the MR device 120, e.g., via the new GW substitution AV interface or via the CDN 140. Different from the dual demultiplexing pipeline splicing model for live substitution shown in FIG. 2, in FIG. 5, the same demultiplexing pipeline is used to feed the ES processors 260-A and 260-V during substitution and the sources are switched at the input to the chunk input 210 corresponding to the targeted content.

In some embodiments, when the playback in the main asset (e.g., M1) starts, the MR device 120 uses the substitution control channel to make the GW device 110 aware of upcoming transitions relating to the media stream connection. In turn, the GW device 110 uses the information received from the substitution control channel to modify the presentation timeline related to the media stream to include one or more PTS discontinuities for transitions such as from main to substitution asset (e.g., M->S), from one substitution asset to another substitution asset (e.g., S1->S2), and/or from substitution to main asset (e.g., S->M). The MR device 120 then uses the modified presentation timeline to determine the current playback position during ongoing playback.

The existing streaming interface connections (e.g., the main AV and control interfaces) between the MR device 120 and the GW device 110 continues to be used for delivering the recorded stream to the MR device 120. In some embodiments, the playback functionality used by the GW device 110 to request the current display PTS from the MR device 120 is modified, e.g., modifying GetPTS command to indicate whether the response is for the main asset or for the substitution. The display PTS is the presentation time stamp of the last rendered video frame and can be used by the GW device 110 to determine the current playback position, i.e. number of seconds from start of the recorded stream. A video PTS references the System Time Clock (e.g., maintained and/or obtained by the clock synchronization unit 250) to advance video presentation, e.g., 50 frames per second. In some embodiments, the GW device 110 resolves the display PTS to an actual playback position within the recorded stream. During targeted content viewing, the reported display PTS relates to the substitution asset. Each transition point during playback is represented by a PTS discontinuity in the presentation timeline. The GW device 110 can use the GetPTS response along with information provided in the via the substitution control channel to map this display PTS to the modified presentation timeline and determine the current playback position within the recorded stream.

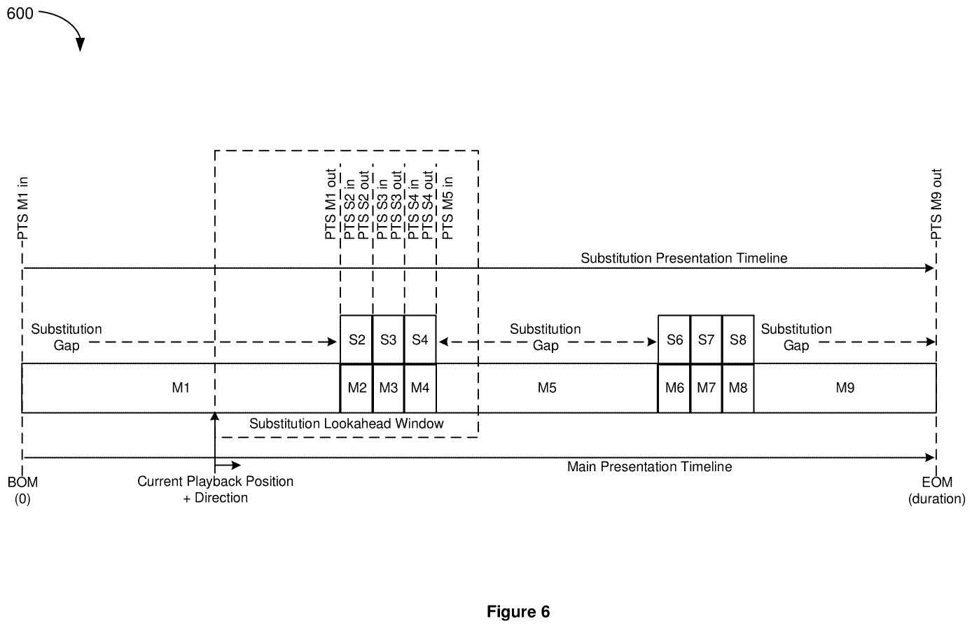

FIG. 6 is a diagram 600 illustrating an exemplary timeline for playback substitution in accordance with various embodiments. The duration of the exemplary timeline includes playing main content (denoted as M1) in the beginning of the media content (BOM) followed by transitioning to three back-to-back substitutions (denoted as S2, S3, and S4) to replace portions of the main content (e.g., M2, M3, and M4). The duration of the exemplary timeline also includes transitioning back to a portion of the main content (denoted as M5) followed by transitioning to another three back-to-back substitutions (denoted as S6, S7, and S8) to replace relevant portions of the main content (e.g., M6, M7, and M8). The duration of the exemplary timeline ends with playing a portion of the main content (denoted as M9) at the end of the media content (EOM).

As explained above with reference to FIG. 1, in some embodiments, during recording of broadcast content, the GW device 110 captures and indexes the rules and splice information messages and saves them with the recorded stream. At playback time, the MR device 120 (FIGS. 1 and 5) maintains a playback substitution window (also referred to as the substitution lookahead window as shown in FIG. 6) and requests from the GW device 110 (FIGS. 1 and 5) one or more transition points within the recorded stream in both forward and reverse directions around the current playback position. For instance, in an initial build-up phase, the MR device 120 (FIGS. 1 and 5) sends commands to the GW device 110 to fetch transitions, such as get next transition and/or get previous transition. In another example, in a steady state phase, the MR device 120 (FIGS. 1 and 5) sends commands to the GW device 110 (FIGS. 1 and 5) to start to look ahead or stop looking ahead to facilitate trick-play of the media stream in forward or reverse direction. In a steady state phase, the playback substitution window has the maximum number of entries (e.g., a configurable number) and the MR device 120 (FIGS. 1 and 5) maintains the steady state phase as playback proceeds.

It should be noted that maintaining the substitution lookahead window shown in FIG. 6 is the same as maintaining the playback substitution window shown in FIG. 3. For live content that is only looking forward, the playback substitution window typically includes what is currently playing and the next transition as shown and described with reference to FIG. 3. As each transition is closed, it can be removed from the playback substitution window. In comparison, the playback substitution window for playback as shown in FIG. 6 can include both forward and reverse directions, and the size of the window is configurable to achieve the desired system performance, e.g., including entries associated with M1, S2, S3, S4, and M5 in the substitution lookahead window shown in FIG. 6.

Prior to the transition between main playback asset M1 and substitution asset S2, a connection is established for the substitution control interface between the MR device 120 (FIGS. 1 and 5) and the GW device 110 (FIGS. 1 and 5). The MR device 120 (FIGS. 1 and 5) then uses the substitution control interface to make the GW device 110 (FIGS. 1 and 5) aware of upcoming transitions related to the main media stream connection. For instance, via the substitution control interface, a splice definition is sent, e.g., sending an open splice command indicating a transition from M1 to S2, the out-point PTS of M1, and the in-point PTS of S2. The MR device 120 (FIGS. 1 and 5) then performs splicing from the media stream to the targeted content according to the splice definition and reports start splicing indicating the transition from M1 to S2.

During the splice transition, the MR device 120 (FIGS. 1 and 5) detects the out-point in the main media stream and signals the GW device 110 (FIGS. 1 and 5) to stall delivery of the main media stream (e.g., stalling streaming main content M1 via the main AV interface connection shown in FIGS. 1 and 5) and start the delivery of the targeted content (e.g., starting to stream targeted content S2 via the substitution AV virtual file interface shown in FIGS. 1 and 5). When the MR device 120 (FIGS. 1 and 5) signals to the GW device that the M1->S2 transition has completed successfully, the GW device 110 (FIGS. 1 and 5) advances the current playback position for the targeted content playback on the MR device 120 (FIGS. 1 and 5) whilst halting delivery of the main media stream, e.g., advancing the current playback position to M2, which has corresponding duration to S2. In some embodiments, the GW device 110 (FIGS. 1 and 5) continues to update the substitution playlist and notifies the MR device 120 (FIGS. 1 and 5) as new entries become available during ongoing playback.

When approaching the end of S2, prior to each of the back-to-back transitions between S2, S3, and S4, the MR device 120 (FIGS. 1 and 5) makes the GW device 110 (FIGS. 1 and 5) aware of upcoming transitions, e.g., S2->S3 and S3->S4 according to the splice definition sent by the viewing and rendering unit 122 (FIG. 1) for all substitutions within the playback substitution window, e.g., a splice definition indicating the opening of splicing from S(N) to S(N+1), the respective out-point PTS, and the respective in-point PTS. The extended streaming unit 126 (FIG. 1) then obtains the substitution assets from the streaming unit 118 (FIG. 1) on the GW device 110 (FIGS. 1 and 5) one at a time according to the transition information. During these splice transitions, the MR device 120 (FIGS. 1 and 5) detects the end of one targeted content delivery and starts presenting the next targeted content, e.g., starting to transition from S(N) to S(N+1). In some embodiments, while the MR device 120 play the substitution content along the substitution presentation timeline, the GW device 110 (FIGS. 1 and 5) advances the current playback position along the main presentation timeline, e.g., advancing the current playback position to M3 and then M4, which have corresponding duration to S3 and S4.

Upon approaching the end of S4 but prior to the transition between S4 and M5, the viewing and rendering unit 122 (FIG. 1) sends a splice definition to the extended streaming unit 126 (FIG. 1) for a transition from S4 to M5, the out-point PTS of S4 and the in-point PTS of M5. The extended streaming unit 126 (FIG. 1) then forwards the splice definition to the streaming unit 118 (FIG. 1) in order to obtain the main media stream from the GW device 110 (FIGS. 1 and 5). During the splice transitions, the MR device 120 (FIGS. 1 and 5) detects the end of the targeted content delivery and resumes delivery of the main media stream at the in-point, e.g., starting to transition from S4 to M5. The GW device 110 (FIGS. 1 and 5) then delivers the main media stream starting from the in-point signaled in the transition. After switching to the main media stream, the same process described above applies to transitioning from M5 to S6 (which has the same duration as M6) to S7 (which has the same duration as M7), then from S7 to S8 (which has the same duration as M8), and subsequently from S8 back to the main media stream M9 (FIGS. 1 and 5).

Using the playback substitution method described herein, for each transition within the playback substitution window, the MR device 120 (FIGS. 1 and 5) sends splice details to the GW device 110 (FIGS. 1 and 5) via the substitution control interface. For a main to substitution asset transition, the MR device 120 (FIGS. 1 and 5) provides the GW device 110 (FIGS. 1 and 5) with the out-point for the main stream and the in-point for the substitution asset. Similarly, for a back-to-back transition between two substitution assets, the MR device 120 (FIGS. 1 and 5) provides the GW device 110 (FIGS. 1 and 5) with the out-point for the first substitution asset and the in-point for the next substitution asset. Finally, for a substitution to main asset transition, the MR device 120 (FIGS. 1 and 5) provides the GW device 110 (FIGS. 1 and 5) with the out-point for the substitution asset and the in-point for the main stream.

The substitution lookahead window illustrated in FIG. 6 can also be used to facilitate trick-play. During I-frame trick-play of the main media stream in the forward direction, in the case of the GW device 110 (FIGS. 1 and 5) detecting a M1->S2 transition point within the substitution lookahead window, the GW device 110 (FIGS. 1 and 5) notifies the MR device 120 (FIGS. 1 and 5) that the GW device 110 (FIGS. 1 and 5) has reached the splice point and suspended I-frame delivery of the main content. The MR device 120 (FIGS. 1 and 5) then controls trick-play for the targeted content. When the MR device 110 (FIGS. 1 and 5) has played across the targeted content, including back-to-back substitutions S2, S2, and S4, it requests the GW device 110 (FIGS. 1 and 5) to continue trick-play of the main media stream. The GW device 110 (FIGS. 1 and 5) resumes I-frame delivery from the in-point for the main media stream provided by the MR device 120 (FIGS. 1 and 5) for the S4 to M5 splice, resuming the I-frame delivery from the M5 in-point.

In some embodiments, for playback near the end of media (EOM) of an ongoing recording, prior to the transition back to main content being received from the broadcast stream, it is necessary to prevent the playback of targeted content extending beyond the end of the current recording, e.g., to prevent a decoder underflow. This is primarily a concern for trick mode playback where the targeted content is being played faster than real time in the forward direction. When the MR device 120 (FIGS. 1 and 5) signals to the GW device 110 (FIGS. 1 and 5) that a transition to a substitution asset has completed successfully and the next transition has not been defined, the GW device 110 (FIGS. 1 and 5) periodically sends the current end-point PTS of the main stream to the MR device 120 (FIGS. 1 and 5), e.g., once per second or according to a pre-defined frequency. The GW device 110 (FIGS. 1 and 5) continues to do this until the next transition has been defined. The MR device 120 (FIGS. 1 and 5) uses the end-point of the main stream in combination with the out-point of the main stream and any prior substitutions to determine the extent of the targeted content that can be played.

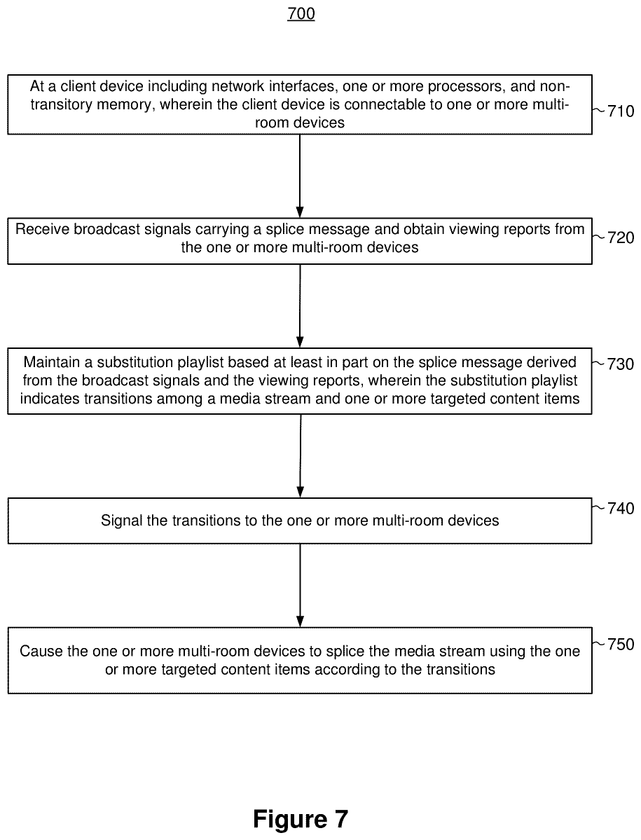

FIG. 7 is a flowchart illustrating a method 700 for client-side targeted content substitution for in-home streaming device in accordance with some embodiments. In some embodiments, as represented by block 710, the method 700 is performed at a client device that includes network interfaces, one or more processors, and non-transitory memory, e.g., the GW device 110 (FIGS. 1 and 4-5). In some embodiments, the client device is connectable to one or more multi-room devices (e.g., the MR device(s) 120, FIGS. 1-2 and 4-5). As represented by block 720, the method 700 includes receiving broadcast signals carrying a splice message (e.g., splice information such as position and duration of a spot for splicing in addition to rules, etc.) and obtaining viewing reports from the one or more multi-room devices, e.g., entry ID, start or stop, and/or timestamps of entering or exiting the display of a first or a last frame of main or targeted content, etc.

As represented by block 720, the method 700 further includes maintaining a substitution playlist based at least in part on the splice message derived from the broadcast signals and the viewing reports, wherein the substitution playlist indicates transitions among a media stream and one or more targeted content items, e.g., the in-point and output and playlist transition, etc. as shown in FIG. 3. As represented by block 730, the method 700 also includes signaling the transitions to the one or more multi-room devices, e.g., via the substitution playlist interface connection shown in FIGS. 1 and 4-5. As represented by block 740, the method 700 additionally includes causing the one or more multi-room devices to splice the media stream using the one or more targeted content items according to the transitions, e.g., from EntryID value of 1 to EntryID value of 2 at out-points (b) as shown in FIG. 3 or from M1 to S2 at PTS M1 out-points and then from S2 to S3 at PTS S2 in-points and PTS S3 out-points, etc. as shown in FIG. 6.

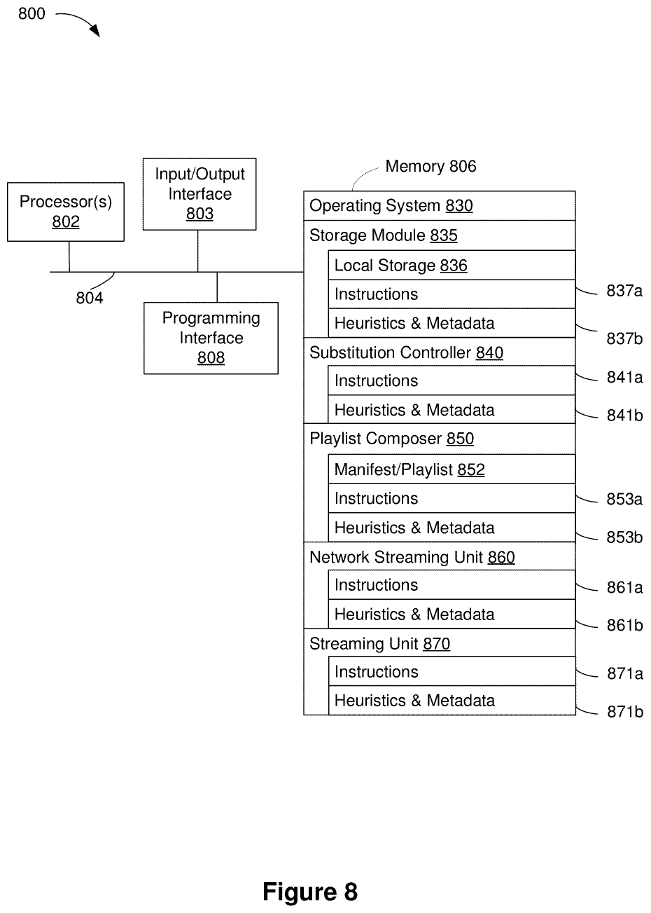

FIG. 8 is a block diagram of an in-home streaming device 800 for client-side targeted content substitution in accordance with some embodiments. In some embodiments, the in-home streaming device 800 corresponds to the GW device 110 (FIGS. 1 and 4-5), a portion of the cloud 130 (FIG. 1), and/or the CDN 140 (FIGS. 1 and 5) and performs one or more of the functionalities described above. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the in-home streaming device 800 includes one or more processing units 802 (e.g., CPU(s)/GPU(s)), one or more input/output interfaces 803 (including one or more network interfaces for connecting with another device such as the MR device 120 in FIGS. 1-2 and 4-5), a memory 806, a programming interface 808, and one or more communication buses 804 for interconnecting these and various other components.

In some embodiments, the communication buses 804 include circuitry that interconnects and controls communications between system components. The memory 806 includes high-speed random access memory, such as DRAM, SRAM, DDR RAM or other random access solid state memory devices; and, in some embodiments, include non-volatile memory, such as one or more magnetic disk storage devices, optical disk storage devices, flash memory devices, or other non-volatile solid state storage devices. The memory 806 optionally includes one or more storage devices remotely located from the CPU(s) 802. The memory 806 comprises a non-transitory computer readable storage medium. Moreover, in some embodiments, the memory 806 or the non-transitory computer readable storage medium of the memory 806 stores the following programs, modules and data structures, or a subset thereof including an optional operating system 830, a storage module 835, a substitution controller 840, an playlist composer 850, a network streaming unit 860, and a streaming unit 870. In some embodiments, one or more instructions are included in a combination of logic and non-transitory memory. The operating system 830 includes procedures for handling various basic system services and for performing hardware dependent tasks.

In some embodiments, the storage module 835 is configured to store and/or manage data to facilitate client-side targeted content substitution. In some embodiments, the storage module 835 includes a location storage 836 (e.g., the location storage 105, FIG. 1) for storing targeted content. To that end, the storage module 835 includes a set of instructions 837a and heuristics and metadata 837b.

In some embodiments, the substitution controller 840 (e.g., the substitution controller 112, FIG. 1) is configured to manage the targeted content in the local storage 836 and campaigns at the household level, e.g., evaluating rules to decide whether to substitute and which targeted content is used for substitution at which MR device, etc. To that end, the substitution controller 840 includes a set of instructions 841a and heuristics and metadata 841b.

In some embodiments, the playlist composer 850 (e.g., the playlist composer 114, FIG. 1) is configured to build and maintain playlists 852 (and/or manifests) referencing the targeted content selected by the substitution controller 840 for substitution. To that end, the playlist composer 850 includes a set of instructions 853a and heuristics and metadata 853b.

In some embodiments, the network streaming unit 860 (e.g., the network streaming unit 116, FIG. 1) is configured to send updates of the playlists 852 to the MR device. To that end, the network streaming unit 860 includes a set of instructions 861a and heuristics and metadata 861b.

In some embodiments, the streaming unit 870 (e.g., the streaming unit 118, FIG. 1) is configured to extend content and control signals to the MR device, e.g., by provisioning interface connection(s) with the MR device according to the signaling from the network streaming unit 860. To that end, the streaming unit 870 includes a set of instructions 871a and heuristics and metadata 871b.

Although the storage module 835, the substitution controller 840, the playlist composer 850, the network streaming unit 860, and the streaming unit 870 are illustrated as residing on a single device 800, it should be understood that in other embodiments, any combination of the storage module 835, the substitution controller 840, the playlist composer 850, the network streaming unit 860, and the streaming unit 870 can reside in separate computing devices in various embodiments. For example, in some embodiments, each of the storage module 835, the substitution controller 840, the playlist composer 850, the network streaming unit 860, and the streaming unit 870 resides on a separate computing device.

Moreover, FIG. 8 is intended more as functional description of the various features which are present in a particular implementation as opposed to a structural schematic of the embodiments described herein. As recognized by those of ordinary skill in the art, items shown separately could be combined and some items could be separated. For example, some functional modules shown separately in FIG. 8 could be implemented in a single module and the various functions of single functional blocks could be implemented by one or more functional blocks in various embodiments. The actual number of modules and the division of particular functions and how features are allocated among them will vary from one embodiment to another, and may depend in part on the particular combination of hardware, software and/or firmware chosen for a particular embodiment.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first device could be termed a second device, and, similarly, a second device could be termed a first device, which changing the meaning of the description, so long as all occurrences of the “first device” are renamed consistently and all occurrences of the “second device” are renamed consistently. The first device and the second device are both devices, but they are not the same device.

The terminology used herein is for the purpose of describing particular embodiments only and is not intended to be limiting of the claims. As used in the description of the embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting”, that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1. A method comprising:
at a client device including network interfaces, one or more processors, and non-transitory memory, wherein the client device is connectable to one or more multi-room devices:
receiving broadcast signals carrying a splice message and obtaining viewing reports from the one or more multi-room devices;
maintaining a substitution playlist based at least in part on the splice message derived from the broadcast signals and the viewing reports, wherein the substitution playlist indicates transitions among a media stream and one or more targeted content items;
signaling the transitions to the one or more multi-room devices; and
causing the one or more multi-room devices to splice the media stream using the one or more targeted content items according to the transitions.

2. The method of claim 1, wherein:
receiving the broadcast signals carrying the splice message includes receiving signaling on a private packet identifier within tuned service, wherein the splice message indicates an optional substitution at out-points; and
maintaining the substitution playlist includes adding to the substitution playlist the optional substation indicating presentation timestamps of the out-points and a duration of the optional substitution; and
signaling the transitions to the one or more multi-room devices includes signaling the presentation timestamps of the out-points and the duration of the optional substitution.

3. The method of claim 1, wherein obtaining the viewing reports from the one or more multi-room devices includes:
opening a substitution playlist interface connection for signaling the transitions; and
receiving the viewing reports from the one or more multi-room devices via the substitution playlist interface connection.

4. The method of claim 1, wherein obtaining the viewing reports from the one or more multi-room devices includes:
obtaining a first viewing report indicating ending display of a last frame prior to the transitions; and
obtaining a second viewing report indicating starting display of a first frame at the multi-room devices upon transitioning among the media stream and the one or more targeted content items.

5. The method of claim 1, wherein obtaining the viewing reports from the one or more multi-room devices include:
receiving a presentation timestamp associated with the transitions from the one or more multi-room devices and an indication of whether the presentation timestamp is for the media stream or the one or more targeted content items.

6. The method of claim 1, wherein maintaining the substitution playlist based at least in part on the splice message derived from the broadcast signals includes:
extracting the splice message and rules associated with campaigns for a substitution spot from the broadcast signals, wherein the splice message specifies a position and duration of the substitution spot;
evaluating the rules for selecting the one or more targeted content items for splicing; and
adding one or more entries corresponding to the one or more targeted content items to the substitution playlist.

7. The method of claim 1, wherein signaling the transitions to be performed on the one or more multi-room devices includes:
notifying the one or more multi-room devices when an entry in the substitution playlist is available; and
triggering the one or more multi-room devices to request transition information associated with the entry, wherein the transition information is derived from the splice message.

8. The method of claim 1, wherein signaling the transitions to be performed on the one or more multi-room devices includes:
receiving a request for the one or more targeted content items from the one or more multi-room devices upon the one or more multi-room devices opening an interface connection for pulling the one or more targeted content items from the client device on-demand according to the transitions.

9. The method of claim 1, wherein causing the one or more multi-room devices to splice the media stream using the one or more targeted content items according to the transitions includes:
receiving signaling from the one or more multi-room devices to stall the media stream to the one or more multi-room devices; and
modifying a presentation timeline related to the media stream to include one or more discontinuities for the transitions in response to receiving the signaling.

10. The method of claim 1, wherein causing the one or more multi-room devices to splice the media stream using the one or more targeted content items according to the transitions includes:
resuming delivering the media stream to the one or more multi-room devices at an in-point signaled by the one or more multi-room devices at an end of the one or more targeted content items.

11. The method of claim 1, wherein causing the one or more multi-room devices to splice the media stream using the one or more targeted content items according to the transitions includes:
continuing to stream the media stream to the one or more multi-room devices while the one or more targeted content items are buffered by the one or more multi-room devices; and
causing the one or more multi-room devices to lock the one or more system time clocks to the media stream when the one or more multi-room devices splice the media stream using the targeted content.

12. The method of claim 1, further comprising:
extending the media stream to the one or more multi-room devices over a first interface connection; and
streaming a first one of the one of more targeted content items to the one or more multi-room devices over a second interface connection, different from the first interface connection.

13. The method of claim 8, further comprising:
signaling a next transition is the media stream; and
causing the one or more multi-room devices to close the second interface connection upon determining by the one or more multi-room devices that the next transition is complete.

14. The method of claim 8, further comprising:
detecting closing of the second connection by the one or more multi-room devices and opening of a third connection by the one or more multi-room devices; and
sending a second one of the one or more targeted content items over the third connection.

15. The method of claim 1, further comprising:
provisioning a substitution control interface for receiving commands from the one or more multi-room devices; and
stalling delivering the media stream to the one or more multi-room devices in response to receiving the commands.

16. The method of claim 1, further comprising:
detecting a splice point to the one or more targeted content items during trick-play of the media stream;
notifying the one or more multi-room devices of reaching the splice point; and
suspending delivery of the media stream and allowing the one or more multi-room devices to control the trick-play for the one or more targeted content items.

17. The method of claim 15, further comprising:
receiving signaling from the one or more multi-room devices indicating playing across the one or more targeted content items and an in-point for the media stream; and
resuming the trick-play of the media stream from the in-point.

18. The method of claim 1, further comprising:
detecting signaling from the one or more multi-room devices indicating successful transitioning to the one or more targeted content items without defining a next transition point; and
sending an end-point of the media stream to the one or more multi-room devices until the next transition point is defined.

19. A client device comprising:
network interfaces connectable to one or more multi-room devices;
one or more processors;
non-transitory memory; and
one or more programs, stored in the non-transitory memory, which, when executed by the one or more processors, cause the client device to:
receive broadcast signals carrying a splice message and obtain viewing reports from the one or more multi-room devices;
maintain a substitution playlist based at least in part on the splice message derived from the broadcast signals and the viewing reports, wherein the substitution playlist indicates transitions among a media stream and one or more targeted content items;
signal the transitions to the one or more multi-room devices; and
cause the one or more multi-room devices to splice the media stream using the one or more targeted content items according to the transitions.

20. A non-transitory memory storing one or more programs, which, when executed by a client device with network interfaces connectable to one or more multi-room devices, and one or more processors, cause the client device to:
receive broadcast signals carrying a splice message and obtain viewing reports from the one or more multi-room devices;
maintain a substitution playlist based at least in part on the splice message derived from the broadcast signals and the viewing reports, wherein the substitution playlist indicates transitions among a media stream and one or more targeted content items;
signal the transitions to the one or more multi-room devices; and
cause the one or more multi-room devices to splice the media stream using the one or more targeted content items according to the transitions.
